(19) United States
(12) Patent Application Publication
(10) Pub. No.: US 2011/0098071 A1
(43) Pub. Date: Apr. 28, 2011

(54) Method for Releasing Resources Allocated by Persistent Scheduling

(76) Inventors: Wook Bong Lee, Gyeonggi-do (KR); Ki Seon Ryu, Gyeonggi-do (KR); Su Nam Kim, Gyeonggi-do (KR); Jeong Ki Kim, Gyeonggi-do (KR); Bin Chul Ihm, Gyeonggi-do (KR)

(21) Appl. No.: 12/741,176

(22) PCT Filed: Dec. 16, 2008
(86) PCT No.: PCT/KR08/07444

§ 371 Date: May 3, 2010

Related U.S. Application Data
(60) Provisional application No. 61/014,066, filed on Dec. 16, 2007.

(30) Foreign Application Priority Data
Apr. 3, 2008 (KR) 10-2008-0031204

(51) Int. Cl. H04B 7/00

(52) U.S. Cl. 455/509

(57) ABSTRACT

A method for releasing resources allocated by persistent scheduling is described. A base station (BS) inserts a persistent allocation release indication message into a control channel, wherein the persistent allocation release indication message includes at least one resource index indicating persistent allocation resources to a mobile station (MS), broadcasts the control channel, and releases the persistent allocation resources corresponding to the resource index. Since a release message for persistent allocation, a channel quality indicator channel, feedback polling allocation, etc. is inserted for transmission into a control channel which can be received by all MSs, overhead which occurs during resource release can be minimized irrespective of transmission rates varying with MSs.

### TECHNICAL FIELD

The present invention relates to resource allocation and release, and more particularly, to a method for effectively releasing resources when resources are persistently allocated to a mobile station.

### BACKGROUND ART

Generally, data of a type such as VoIP (Voice over Internet Protocol) has a regular transmission period. Especially, when using adaptive multi-rate (AMR) codec etc., data of an active user, i.e., data of a user who is communicating is generated every 20 ms and data of an inactive user is generated every 160 ms. Using such characteristics, a persistent scheduling method has been discussed. Persistent scheduling refers to a method for a mobile station to transmit data by a determined period, position, and method using an initially allocated resource.

FIG. 1 illustrates an example of a process of allocating a persistent allocation resource for a conventional VoIP service.

A mobile station (MS) generates a VoIP service (step 110) and transmits a dynamic service addition request (DSA-REQ) message to a base station (BS) (step 120).

The BS may initiate the process of allocating the persistent allocation resource. In this case, the VoIP service may be generated by the BS.

The BS receiving the DSA-REQ message transmits a dynamic service addition response (DSA-RSP) message including allocation region information and persistent allocation allowable information to the MS (step 130). The MS receiving the DSA-RSP message transmits a dynamic service addition acknowledgement (DSA-ACK) message to the BS and stores persistent scheduling information contained in the DSA-RSP message (step 140). The MS transmits and receives a packet to and from the BS using the stored scheduling information (step 150).

Meanwhile, a method of appropriately releasing the persistent allocation resource is required when circumstances such as change in status of the MS occur.

FIG. 2 illustrates an example of a process of releasing a persistent allocation resource in a conventional VoIP service.

If a BS desires to delete an allocated resource, the BS transmits a resource delete request (Resource_Delete-REQ) message to a corresponding MS (step 210). The MS receiving the request message transmits a resource delete response (Resource_Delete-RSP) message to the BS and deletes related information (step 220). The BS may allocate a resource to the MS using dynamic scheduling, for example, using a MAP information element (IE) from the next period, and the MS transmits and receives a packet to and from the BS using the resource allocated through a map.

Usually uplink feedback channel is also allocated periodically. A method of releasing the allocated feedback channel is needed.

FIG. 3 illustrates an example of a process of releasing a subchannel resource allocated to a specific MS and allocating the released resource to another MS.

It is assumed that a resource unit of a time axis is a subframe and a resource unit of a frequency axis is a subchannel. Although a resource region may be defined in a time, frequency, code, or antenna domain, it is assumed in FIG. 3 that resources are allocated only in time and frequency regions.

If a BS allocates a resource to a subchannel of a subframe 1 at a time period of 5 for data transmission and reception to and from an MS 1, resource allocation information is transmitted to the MS 1 through a control signal which is in charge of the resource allocation of the subframe 1.

Next, even though the resource is not allocated to the MS 1, the MS 1 transmits or receives data through the subchannel 1 of a subframe 6 or the subchannel 1 of a subframe 11.

If data to be transmitted by the MS 1 is no longer present or if the status of the MS 1 is changed so resource allocation is not needed after a subframe 16, the resource allocation may be released by the following method.

First, a BS may directly request an MS to release resources as illustrated in FIG. 2. However, since the BS should individually transmit and receive messages related to resource release to and from the MS, overhead of a control signal for resource allocation is increased. Namely, when the MS is requested to release resources, additional information as well as release information is required and thus unnecessary overhead is increased.

Second, the BS may automatically request the MS to release resources by allocating a corresponding resource to another MS which is to use the resource to be released. This method has the following problems. To reduce resources occupied by a downlink control signal, when the control signal is transmitted to each MS or user groups each having a few users, a transmission rate is differently set according to each MS or group, thereby efficiently using the resources occupied by the control signal.

However, if the transmission rate differs according to the MS or group, for example, if the transmission rate which can be received by an MS 1 is lower than the transmission rate which can be received by an MS 2, the MS 1 can not demodulate a control signal for allocating resources thereto by the MS 2. Hence, the resource can not be appropriately released.

### DISCLOSURE

### Technical Problem

An object of the present invention devised to solve the problem lies in providing a method for releasing resources allocated by persistent scheduling with minimum overhead irrespective of a transmission rate of an MS.

### Technical Solution

The object of the present invention can be achieved by providing a method of releasing resources, including inserting a persistent allocation release indication message into a control channel, wherein the persistent allocation release indication message includes at least one resource index indicating persistent allocation resources to an MS, broadcasting the control channel, and releasing the persistent allocation resources corresponding to the resource index.

A joint coding scheme may be applied to the persistent allocation release indication message.

The resource index may include at least one of a bitmap, information about start and end positions of resources to be released, and the start position and the number of resources to be released, wherein the bitmap indicates whether at least one subchannel is released among resources allocated to MSs.

The resource index may have a length varying according to the number of resources to be released.

The method may further include allocating, upon receiving a resource change request from any MS, the released persistent allocation resources to the MS which has transmitted the resource change request.

In another aspect of the present invention, provided herein is a method of releasing resources, including inserting a persistent allocation release indication message into a control channel, wherein the persistent allocation release indication message includes at least one connection ID of MSs, broadcasting the control channel, and releasing persistent allocation resources corresponding to the connection ID.

The method may further include allocating, upon receiving a resource change request from any MS, the released persistent allocation resources to the MS which has transmitted the resource change request.

In still another aspect of the present invention, provided herein is a method of releasing resources, including inserting a persistent allocation release indication message into a control channel, wherein the persistent allocation release indication message includes at least one ID of channel quality indicator (CQI) channels of MSs, broadcasting the control channel, and releasing persistent allocation resources corresponding to the at least one ID of the CQI channels.

The method may further include allocating, upon receiving a resource change request from any MS, the released persistent allocation resources to the MS which has transmitted the resource change request.

In a further aspect of the present invention, provided herein is a method of releasing resources, including inserting a feedback polling allocation release indication message into a control channel, wherein the feedback polling allocation release indication message includes at least one connection ID of MSs, broadcasting the control channel, and releasing persistent allocation resources corresponding to the connection ID.

### Advantageous Effects

According to the exemplary embodiments of the present invention, a release message for persistent allocation, a channel quality indicator channel, feedback polling allocation, etc. is inserted for transmission to a control channel which can be received by all MSs. Therefore, overhead which occurs during resource release can be minimized irrespective of transmission rates varying with MSs.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates an example of a process of allocating a persistent allocation resource for a conventional VoIP service;

FIG. 2 illustrates an example of a process of releasing a persistent allocation resource in a conventional VoIP service;

FIG. 3 illustrates an example of a process of releasing a subchannel resource allocated to a specific MS and allocating the released resource to another MS;

FIG. 4 illustrates a signal flow of a resource release method according to an exemplary embodiment of the present invention;

FIG. 5 illustrates a signal flow of a resource release method according to another exemplary embodiment of the present invention;

FIG. 6 illustrates a signal flow of a resource release method according to a further exemplary embodiment of the present invention;

FIG. 7 illustrates an example of a frame structure in which a resource release message is added according to the exemplary embodiments of the present invention; and

FIG. 8 illustrates a resource change request process in FIG. 4.

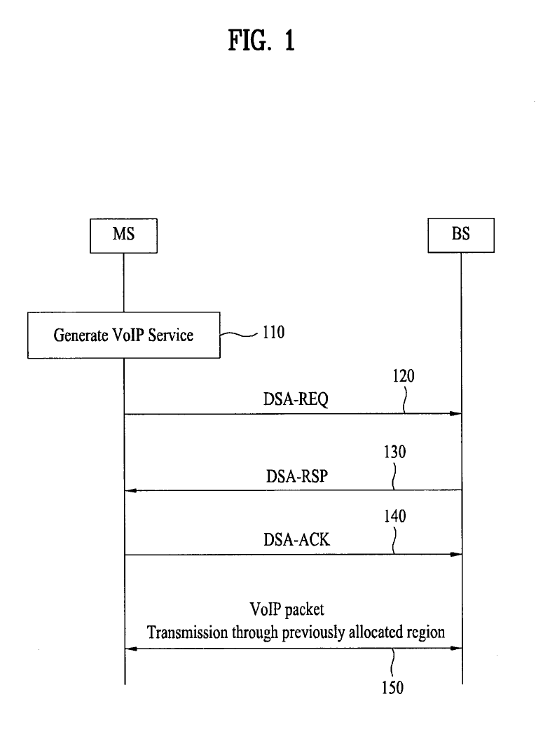

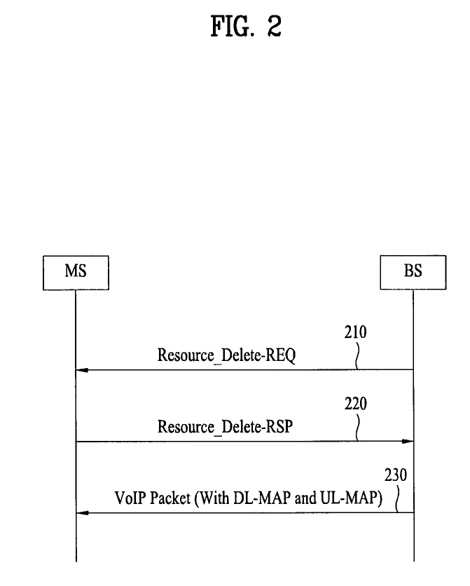

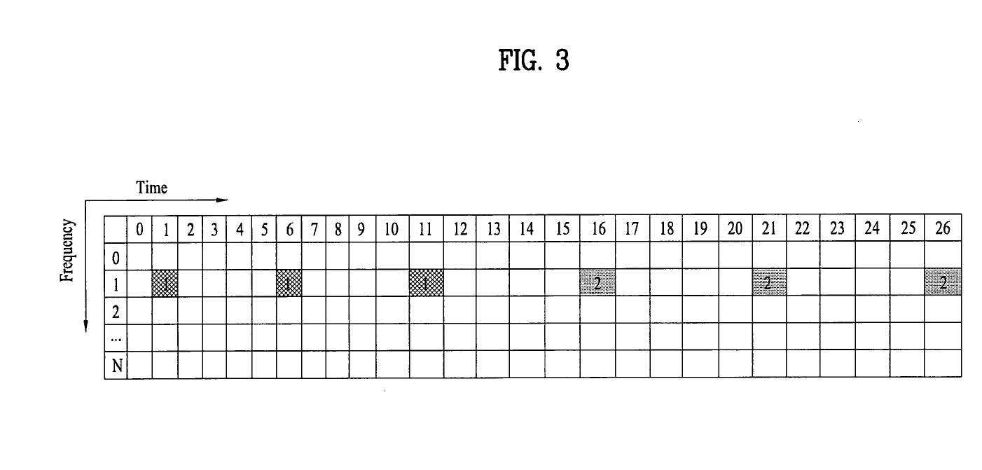

### BEST MODE

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention.

According to the exemplary embodiments of the present invention, if resources to be released are present, a BS informs an MS of resource region information to be released through a control signal which can be received by all MSs. Since the control signal indicates a resource region to be released, overhead is not great and efficient resource release can be implemented.

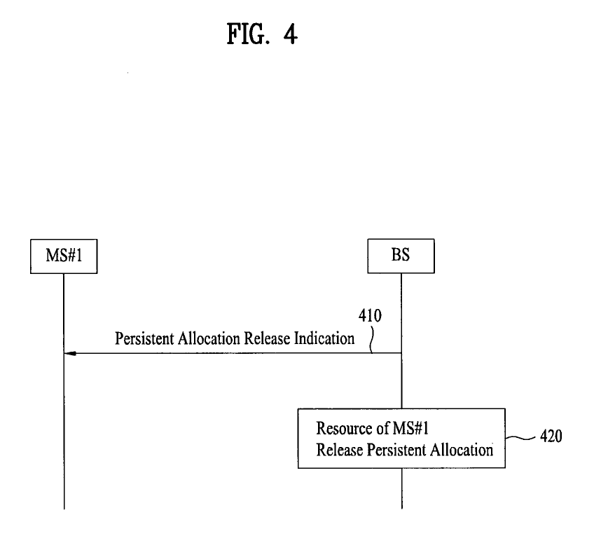

FIG. 4 illustrates a signal flow of a resource release method according to an exemplary embodiment of the present invention.

If there are resources to be released, a BS broadcasts a control channel including a persistent allocation release indication message (step 410). The persistent allocation release indication message includes at least one resource index or at least one MS connection identifier. The resource index indicates which persistent allocation resource is released. A joint coding scheme may be applied to the persistent allocation release indication message so that all MSs can decode the message.

A first MS MS#1 confirms that a persistent allocation resource thereof is to be released through a control channel broadcast by the BS. Next, the BS releases a persistent allocation resource corresponding to the broadcast resource index or the connection identifier (step 420). Thereafter, resources for transmitting and receiving data to and from the MS are allocated through a MAP IE.

The following Table 1 illustrates an example of the persistent allocation release indication message.

TABLE 1

| | Number of | |
|---|---|---|
| | bits | Description |
| Persistent Allocation | 1 | If 0, there are no |
| Release Indication | | released resources. |
| | | If 1, there are |
| | | released resources. |
| If (Persistent Allocation | | |
| Release Indication = = 1){ | | |
| Released Resource | Variable | |
| Index | | |
| } | | |

In Table 1, the released resource index may be a bitmap type. If the number of subchannels is N and a released resource is a subchannel 1, an MS may be informed of the released resource using a bitmap comprised of N bits. For instance, if N is 7, a bitmap is 0100000.

If N is large, the following method may be used to prevent the bitmap from being increased.

TABLE 2

Number of released resources : K
For (k=0; k<K; k++){
Resource index
}

In this case, a resource index may be expressed by (K+1)*log 2(N) bits. If K is small, this method may be more effective than the bitmap method.

Meanwhile, the resource index may be information indicating only the start and end positions of released resources or information indicating the start position of released resources and the number of released resources. Moreover, the resource index may have a variable bit length according to the number of released resources.

The above-described resource indexes are only exemplary and the MS may be informed of the position of a released resource through other methods.

Alternatively, a persistent allocation resource may be released by broadcasting an identifier (ID) or a connection identifier (CID) of an MS using resources to be released.

The following Table 3 illustrates an example of a persistent allocation release indication including the CID or reduced connection identifier (RCID).

TABLE 3

| | Number of | |
|---|---|---|
| | bits | Description |
| Persistent Allocation Release Indication | 1 | If 0, there are no released |
| | | resources |
| | | If 1, there are released resources |
| If (Persistent Allocation Release Indication = = 1){ | | |
| Number of Deallocated Connection | Variable | The size of this is related to |
| | | maximum allowable allocated |
| | | users for one frame/subframe. |
| for (i=0; i<Number of Deallocated Connection;i++){ | | |
| CID/RCID | Variable | CID is connection ID, which is a |
| | | uniquely identified connection |
| | | between a base station and a |
| | | mobile station. RCID is a |
| | | reduced version of CID. |
| } | | |
| } | | |

In Table 3, the resource index may have a variable bit length according to the number of released resources.

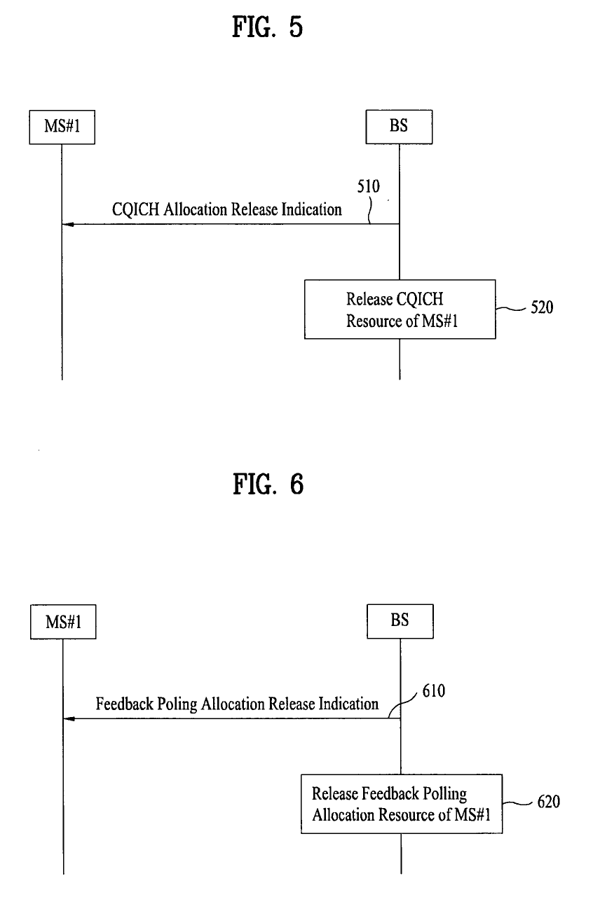

FIG. 5 illustrates a signal flow of a resource release method according to another exemplary embodiment of the present invention.

If there is a released channel among channels for receiving channel quality information of an MS, a BS broadcasts a control channel including channel quality indicator channel (CQICH) allocation release indication message (step 510). The CQICH allocation release indication includes at least one CQICH ID. A joint coding scheme may be applied to the CQICH allocation release indication message so that all MSs can decode the message. A first MS MS#1 confirms that a CQICH thereof is to be released through a control channel broadcast by the BS. Next, the BS releases a resource of the CQICH corresponding to an ID of the broadcast CQICH (step 520).

The following Table 4 illustrates an example of the CQICH allocation release indication message including a CQICH ID (CQICH_ID).

TABLE 4

| | Number | |
|---|---|---|
| | of bits | Description |
| CQICH Allocation Release Indication | 1 | If 0, there are no released resources. |
| | | If 1, there are released resources. |
| If (CQICH Allocation Release Indication = = 1){ | | |
| Number of Deallocated Connection | Variable | The size of this is related to number |
| | | of bits of CQICH_ID or maximum |
| | | allowable allocated CQICH for one |
| | | frame/subframe. |
| for (i=0; i<Number of Deallocated CQICH;i++){ | | |
| CQICH_ID | Variable | Index to uniquely identify the |
| | | CQICH resource assigned to the SS. |
| | | The size of this field can be |
| | | indicated by system information. |
| } | | |
| } | | |

In Table 4, CQICH_ID may have a variable bit length according to the number of released channels.

FIG. 6 illustrates a signal flow of a resource release method according to a further exemplary embodiment of the present invention. If there is a channel to be released among channels for receiving feedback information of a message type, a BS broadcasts a control channel including a feedback polling allocation release indication message (step 610). The feedback polling allocation release indication message includes at least one CID. A first MS MS#1 confirms that a feedback channel thereof is to be released through a control channel broadcast by the BS. Next, the BS releases a resource of the feedback channel corresponding to an ID of the broadcast feedback channel (step 620).

The following Table 5 indicates an example of the feedback polling allocation release indication message including CID/RCID.

TABLE 5

| | Number | |
|---|---|---|
| | of bits | Description |
| Feedback Polling Allocation Release Indication | 1 | If 0, there are no released |
| | | resources. |
| | | If 1, there are released |
| | | resources. |
| If (Feedback Polling Allocation Release Indication = = 1){ | | |
| Number of Deallocated Feedback Polling Allocation | Variable | The size of this is related to |
| | | number of bits of CID or |
| | | maximum allowable allocated |
| | | connections. |
| for (i=0; i<Number of Deallocated Feedback Polling | | |
| Allocation;i++){ | | |
| CID/RCID | Variable | CID is connection ID, which is |
| | | a uniquely identified |
| | | connection between a base |
| | | station and a mobile station. |
| | | RCID is a reduced version of |
| | | CID. |
| } | | |
| } | | |

In Table 5, CID/RCID may have a variable bit length according to the number of released channels.

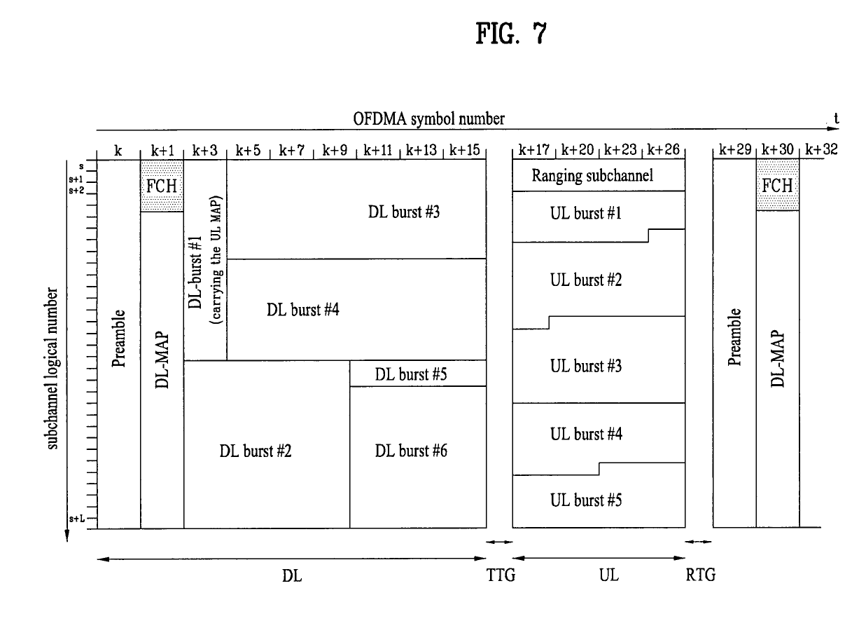

FIG. 7 illustrates an example of a frame structure in which a resource release message is added according to the exemplary embodiments of the present invention.

FIG. 7 shows a frame used in a broadband wireless access system, for example, Institute of Electrical and Electronics Engineers (IEEE) 802.16e. The frame includes a preamble, a frame control header (FCH), downlink (DL)-MAP, uplink (UL)-MAP, DL bursts, UL bursts, etc. FCH is used to provide channel allocation information and channel coding information related to DL-MAP. DL-MAP and UL-MAP indicate a medium access control (MAC) message informing an MS of channel resource allocation in downlink and uplink. A BS may inform MSs of resource regions allocated to the respective MSs using DL-MAP/UL-MAP.

When the BS informs the MSs of allocated regions in downlink using DL-MAP, the BS may inform the MSs of the allocated regions in a block form, using orthogonal frequency division multiple access (OFDMA) symbol offset, subchannel offset, the number of OFDMA symbols, and the number of subchannels. Furthermore, when the BS informs the MSs of allocated resource regions in uplink using UL-MAP, the BS may use duration information.

The resource release messages described in the exemplary embodiments of the present invention may be inserted to a control channel such as FCH and DL-MAP. In addition, the resource release messages may be added to a submap of each subframe. However, positions within a frame in which the resource releases messages can be inserted are not limited to a range described herein.

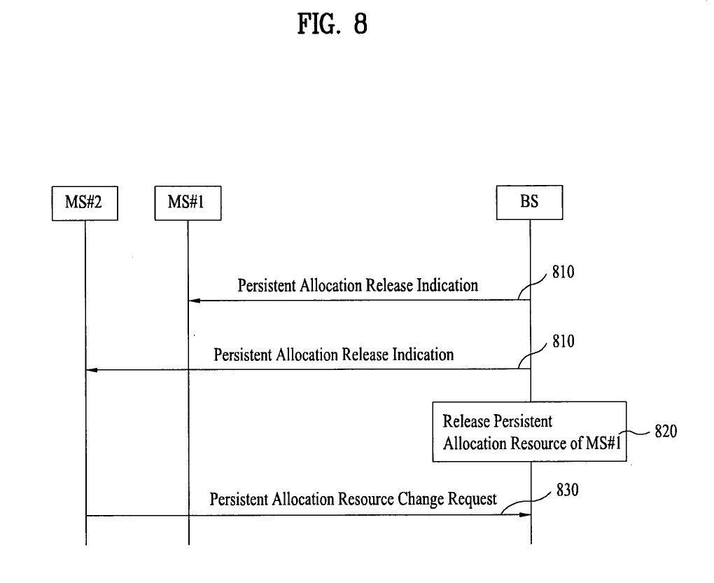

FIG. 8 illustrates a resource change request process in FIG. 4.

If there is a released resource, a BS broadcasts a control channel including a persistent allocation release indication message (step 810). The persistent allocation release indication message includes a resource index of a persistent allocation resource of a first MS MS#1.

The first MS MS#1 confirms that the persistent allocation resource thereof is to be released through the control channel broadcast by the BS and simultaneously a second MS MS#2 confirms that resource allocation thereof is to be continued.

Next, the BS releases the resource of the MS MS#1 corresponding to the broadcast resource index (step 820). The BS then allocates a resource for transmitting and receiving data to and from the first MS MS#1 through a MAP IE.

If the second MS MS#2 desires to use the resource which has been allocated to the first MS MS#1, the second MS MS#2 transmits a persistent allocation resource change request message to the BS (step 830). Upon receipt of the resource change request message from the second MS MS#2, the BS allocates the resource released from the first MS MS#1 to the second MS MS#2. At this time, resource change may be implemented by swapping a persistent allocation resource of the second MS MS#2 and the persistent allocation resource of the first MS MS#1.

Alternatively, the resource allocation of the second MS MS#2 may be changed by the determination of the BS without any request of the second MS MS#2. For example, if it is determined based on resource scheduling information of the BS that a resource allocated to the second MS MS#2 may be shifted to a resource region released from the first MS MS#1, the BS may allocate a resource released from the first MS MS#1 to the second MS MS#2 and then broadcast a message including the changed resource allocation information.

In more detail, assuming that a first MS uses resource indexes 1, 2, and 3, a second MS uses resource indexes 4 and 5, and a third MS uses resource indexes 6, 7, and 8, if resource allocation to the second MS is released, the released resource may be allocated to the third MS according to a request of the third MS or to the determination of a BS. Namely, after persistent allocation resource to the second MS is released, the persistent allocation resource may be changed such that the third MS can use resources of the resource indexes 4, 5, and 6, including the resource released from the second MS.

Schemes such as Persistent Allocation, CQICH Allocation, Feedback Polling Allocation Release may be implemented by the following procedures.

If indications needed to implement the schemes is transmitted through the broadcast channel and there exists resources to be release according to the indications (e.g. where a specific indication has a value of 1), an additional control channel may be transmitted.

For example, a Persistent Allocation indication field may be generated in an area which non-user specific information is transmitted in IEEE802.16m. If the Persistent Allocation indication field has a value of 1, a control channel which has a release message is additionally transmitted.

In this case, the control channel may be encoded in a way separated from other control channel. In this case, a mask of a CRC in the encoded block may be a predeterminded mask type suitable for a persistent allocation release.

Alternatively, the control channel may be transmitted without transmitting the indication field.

Further, the said methods may be applied to the other persistent allocation release schemes.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention provides a method for effectively releasing resources which are not allocated by a MAP message such as a persistent allocation resource and is applicable to devices such as a BS, an MS, etc. of Worldwide Interoperability for Microwave Access (WiMAX) 1.x, IEEE 802.16m, and systems which are compatible with WiMAX 1.x and IEEE 802.16m.

1. A method of releasing, by a base station (BS), resources allocated to a mobile station (MS) by persistent scheduling, the method comprising:
inserting a persistent allocation release indication message into a control channel, wherein the persistent allocation release indication message includes at least one resource index indicating persistent allocation resources to the MS;
broadcasting the control channel; and
releasing the persistent allocation resources corresponding to the resource index.

2. The method of claim 1, wherein a joint coding scheme is applied to the persistent allocation release indication message.

3. The method of claim 1, wherein the resource index includes at least one of a bitmap, information about start and end positions of resources to be released, and the start position and the number of resources to be released, wherein the bitmap indicates whether at least one subchannel is released among resources allocated to MSs.

4. The method of claim 1, wherein the resource index has a length varying according to the number of resources to be released.

5. The method of claim 1, further comprising allocating, upon receiving a resource change request from any MS, the released persistent allocation resources to the MS which has transmitted the resource change request.

6. A method of releasing, by a base station (BS), resources allocated to a mobile station (MS) by persistent scheduling, the method comprising:
inserting a persistent allocation release indication message into a control channel, wherein the persistent allocation release indication message includes at least one connection identifier (ID) of MSs;
broadcasting the control channel; and
releasing persistent allocation resources corresponding to the connection ID.

7. The method of claim 6, further comprising allocating, upon receiving a resource change request from any MS, the released persistent allocation resources to the MS which has transmitted the resource change request.

8. A method of releasing, by a base station (BS), resources allocated to a mobile station (MS) by persistent scheduling, the method comprising:
inserting a persistent allocation release indication message into a control channel, wherein the persistent allocation release indication message includes at least one identifier (ID) of channel quality indicator (CQI) channels of MSs;
broadcasting the control channel; and
releasing persistent allocation resources corresponding to the at least one ID of the CQI channels.

9. The method of claim 8, further comprising allocating, upon receiving a resource change request from any MS, the released persistent allocation resources to the MS which has transmitted the resource change request.

10. A method of releasing, by a base station (BS), resources allocated to a mobile station (MS) by persistent scheduling, the method comprising:
inserting a feedback polling allocation release indication message into a control channel, wherein the feedback polling allocation release indication message includes at least one connection identifier (ID) of MSs;
broadcasting the control channel; and
releasing persistent allocation resources corresponding to the connection ID.

11. A method of releasing, by a base station (BS), resources allocated to a mobile station (MS) by persistent scheduling, the method comprising:
broadcasting a persistent allocation release indication field;
transmitting a control channel, wherein the control channel includes at least one resource index indicating persistent allocation resources to the MS; and
releasing the persistent allocation resources corresponding to the resource index.
